(19) United States
(12) Patent Application Publication
(10) Pub. No.: US 2024/0340656 A1
(43) Pub. Date: Oct. 10, 2024

(54) Synchronized Activation of Semi-Static Resource Configurations for Integrated Access and Backhaul Multi-Parent Nodes

(71) Applicant: Telefonaktiebolaget LM Ericsson (publ), Stockholm (SE)

(72) Inventors: Ritesh Shreevastav, Upplands Väsby (SE); Filip Barac, Huddinge (SE); Boris Dortschy, Vendelsö (SE); Marco Belleschi, Solna (SE); Magnus Åström, Lund (SE); Henrik Sahlin, Mölnlycke (SE); Lei Bao, Göteborg (SE)

(21) Appl. No.: 18/292,569

(22) PCT Filed: Jul. 27, 2022
(86) PCT No.: PCT/EP2022/071086

§ 371 Date: Jan. 26, 2024

Related U.S. Application Data
(60) Provisional application No. 63/226,435, filed on Jul. 28, 2021.

(51) Int. Cl. H04W 24/02; H04W 56/00; H04W 76/15; H04W 88/08

(52) U.S. Cl. CPC H04W 24/02; H04W 56/0015; H04W 76/15; H04W 88/08

(57) ABSTRACT

A method performed by an integrated access and backhaul (IAB) donor node (102, 802a, 802b) for synchronized activation of a resource configuration. The method includes determining (906), by the IAB-donor node, a synchronized update time for performing a synchronized configuration update in a plurality of parent IAB-nodes (804a, 804b) and/or a child IAB-node (806). The child IAB-node is dual-connected to the plurality of parent IAB-nodes. The method additionally includes transmitting (908), by the IAB-donor node, the synchronized update time to at least each parent IAB-node and/or the child IAB-node.

### TECHNICAL FIELD

The present disclosure relates generally to communications, and more particularly to communication methods and related devices and nodes supporting wireless communications.

### BACKGROUND

In 3GPP TR 38.874 NR; Study on Integrated Access and Backhaul V16.0.0 (3GPPP Rel-16 IAB), January 2019, from the RAN1 perspective, only Inter-carrier Inter-band multi-parent operation is supported; from the RAN 3 perspective, only Intra-donor multi-parent case is supported. In RP-211548, “New WID on Enhancements to Integrated Access and Backhaul,” Qualcomm, RAN #92e, June 2021, Inter-donor multi-parent operation and Inter-carrier Intra-band operation will be specified. In the Intra-donor multi-parent case, the single IAB-donor-CU or IAB-donor node can coordinate the usage of overlapping resources between the two-parent links, as well as the usage of overlapping resource between each parent link and the child link(s). For example, the resource coordination could be with respect to the following configuration parameters:
TDD pattern (Uplink/Downlink/Flexible) alignment between the parent links.
H/S/NA resource configuration of IAB-DU(s) and the parent IAB-DU(s)
Explicit indication of IAB-DU soft resource
Regarding the Inter-donor multi-parent case, the semi-static configurations will be provided to the IAB-node by the two IAB-donors and a coordination between the two IAB-donors will be needed.

Normally, it is assumed that the IAB-donor-CU(s) should solve the conflict of semi-static resource configurations (e.g., D/U/F and H/S/NA resource configurations) between the two parent IAB-nodes, and/or between the dual-connected IAB-node and each parent IAB-node. In addition, it is assumed that the parent IAB-node can be made aware of not only its own semi-static configurations, but also the semi-static configurations of the peer parent IAB-node, and the dual-connected IAB-node or child IAB-node—this is because the conflict between these three configurations should be avoided.

However, in a multi-hop IAB network, the arrival time of F1 messages at different IAB-nodes may vary significantly depending on the number of hops to the IAB-donor-CU. If the updated configuration from the IAB-donor-CU (carried in an F1-message) is applied directly after it is received, there could be a timing misalignment in configuration execution at the two parent IAB-nodes, since the IAB-nodes may receive the configuration update messages from the IAB-donor node or IAB-donor nodes at different times. Consequently, it may cause undesirable configuration and resource conflicts between the parent IAB-nodes, or between any parent IAB-node and the dual-connected IAB-node or child IAB-node. Unexpected collision in DL/UL directions may also generate severe interference situation. If the execution timing is unknown to the IAB-donor-CU, it means the centralized coordination may fail. Furthermore, the semi-static configuration of the peer parent IAB-node and/or the IAB-node may be encoded in different F1-messages, which can also give rise to undesirable configuration conflict.

### SUMMARY

Certain aspects of the disclosure and their embodiments may provide solutions to these or other challenges. The invention discloses methods and systems to ensure time-aligned execution of configurations pertaining to the links between an IAB-node and its (multiple) parent IAB-nodes. The IAB-node is also referred to herein as a child IAB-node. The proposed solution applies for both intra- and inter-donor multiple connectivity of an IAB-node, for the following cases and any combination thereof:
All parents of an IAB-node are IAB-nodes,
All parents of the IAB-node are IAB-donor-DUs,
Some parents of the IAB-node are IAB-nodes while some parents are IAB-donor-DUs.

Based on the estimated packet delay information between an IAB-donor-CU and a certain IAB-node (served by two parents, both of which are under this IAB-donor-CU), the IAB-donor-CU can control the activation timing of the updated semi-static configurations to avoid potential configuration conflicts due to misaligned configuration activation timing.

In the inter-donor-DC scenario, the two IAB-donor-CUs or IAB-donor nodes can exchange the packet delay information regarding the two parent IAB-nodes, and the dual-connected IAB-node or child IAB-node.

The invention consists of two aspects for intra-donor topology, i.e., IAB-node served by two or more parents under the same IAB-donor or IAB-donor node.
a) How IAB-donor-CU determines the activation time required for each IAB-node.
b) How each parent IAB-node provides the update command to dual-connected IAB-node (or child IAB-node), in a way synchronized with the provision of the command to the node by the other parent.

The invention consists of three aspects for inter-donor topology, i.e., IAB-node served by two or more parents under at least two IAB-donors or IAB-donor nodes.
a) Exchange of information between two IAB-donor-CUs with regards to which IAB-donor-CU will set the activation time and provide the information to each parent node.
b) How IAB-donor-CU determines the activation time of the command pertaining for each IAB-node.
c) How each parent IAB-node provides the synchronized update command to dual-connected IAB-node.

A mechanism is provided where the IAB-donor-CU or IAB-donor node takes into account the delay associated with each IAB-node (packet travel time from IAB-donor to IAB-node). When a synchronized update is required to be triggered by multiple parent IAB-nodes towards a dual-connected IAB-node or child IAB-node, the IAB-donor-CU provides the activation time (or activation delay) that each parent IAB-node will take into account.

The synchronized update information or time from each parent node to the dual-connected IAB-node may be sent via design of a new Level 2 Medium Access Control-Control Element (L2 MAC CE) activation/deactivation command or via a new IAB specific Downlink Control Indicator (DCI), or via a Backhaul Adaption (BAP) control Protocol Data Unit (PDU).

Certain embodiments may provide one or more of the following technical advantage(s). When an IAB-node connects to multiple parent IAB-nodes, this invention provides time coordination on the activation of the semi-static resource configurations at the multi-parent IAB-nodes. Thereby unexpected configuration conflict, as well as interference situations, due to misaligned execution timing can be avoided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of an example of a multi-hop deployment in an integrated access and backhaul (IAB) network according to some embodiments of inventive concepts;

FIG. 2 is an illustration of an example of uplinks and downlinks between a parent IAB-node and a child IAB-node according to some embodiments of inventive concepts;

FIG. 3 is an illustration of an example of an IAB architecture according to some embodiments of inventive concepts;

FIG. 4 is illustration of an example of a spanning tree (ST) topology IAB network and a directed acyclic graph (DAG) topology IAB network according to some embodiments of inventive concepts;

FIG. 5 is an illustration of an example of an IAB network including multiple parent IAB-nodes according to some embodiments of inventive concepts;

FIG. 6 is an illustration of examples of an inter-donor IAB topology according to some embodiments of inventive concepts;

FIG. 7 is an illustration of an example misalignment of configuration execution timing at parent IAB-nodes due to varied propagation delay between the IAB-donor-CU or IAB-donor node and each parent IAB-node according to some embodiments of inventive concepts;

FIG. 8A is an illustration of an example of an IAB inter-donor network according to some embodiments of inventive concepts;

FIG. 8B is an illustration of an example of signaling in the IAB inter-donor network in FIG. 8A for performing a synchronized activation of a resource configuration in according to some embodiments of inventive concepts;

FIG. 9 is a flow chart of an example of a method performed by an IAB-donor node for synchronized activation of a resource configuration according to some embodiments of inventive concepts;

FIG. 10 is a flow chart of an example of a method for performed by a parent IAB-node for synchronized activation of a resource configuration according to some embodiments of inventive concepts;

FIG. 11 is an example of IAB network including inter-carrier New Radio-Dual Connectivity (NR-DC) according to some embodiments of inventive concepts;

FIG. 12 is an illustration of an example of synchronized activation of a resource configuration in an IAB network according to some embodiments of inventive concepts;

FIG. 13 is an illustration of another example of synchronized activation of a resource configuration in an IAB network according to some embodiments of inventive concepts;

FIG. 14 is an illustration of another example of synchronized activation of a resource configuration in an IAB network according to some embodiments of inventive concepts;

FIG. 15 is an illustration of a further example of synchronized activation of a resource configuration in an IAB network according to some embodiments of inventive concepts;

FIG. 16 is an example of MAC CE signaling according to some examples of inventive concepts;

FIG. 17 is a block diagram illustrating a wireless device UE according to some embodiments of inventive concepts;

FIG. 18 is a block diagram illustrating a radio access network RAN node (e.g., a base station eNB/gNB) according to some embodiments of inventive concepts;

FIG. 19 is a block diagram illustrating a core network CN node (e.g., an AMF node, an SMF node, etc.) according to some embodiments of inventive concepts;

FIG. QQ1 is a block diagram of a communication system in accordance with some embodiments;

FIG. QQ2 is a block diagram of a user equipment in accordance with some embodiments

FIG. QQ3 is a block diagram of a network node in accordance with some embodiments;

FIG. QQ4 is a block diagram of a host computer communicating with a user equipment in accordance with some embodiments;

FIG. QQ5 is a block diagram of a virtualization environment in accordance with some embodiments; and

FIG. QQ6 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Densification via the deployment of increasing base stations (be they macro or micro base stations) is one of the mechanisms that can be employed to satisfy the ever-increasing demand for more and more bandwidth/capacity in mobile networks. Due to the availability of more spectrum in the millimeter wave (mmw) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

The present invention is presented on an example of IAB-MT using NR-DC or EN-DC to connect to two parents and IAB-donors. Solutions for the dual-parent (i.e., DC) scenario are described herein, but the methods can be extended to the multi-parent scenario, the parents being under the same or different IAB-donor-CUs. The proposed solution applies for both intra- and inter-donor multiple connectivity of an IAB-node, for the following cases and any combination thereof:
All parents of an IAB-node are IAB-nodes,
All parents of the IAB-node are IAB-donor-DUs,
Some parents of the IAB-node are IAB-nodes while some parents are IAB-donor-DUs.

The terms “network function” and “IAB-donor-CU” are used interchangeably. As used herein, a network-function is the unit which provides resource configurations to an IAB-DU and/or IAB-MT. The network function can be located:
at a node in the RAN (for example an IAB-donor-CU),
as a separate function residing in the core network (for example the Operation, Administration and Management (OAM) function), or
as a virtual node in the cloud (including the above functions).

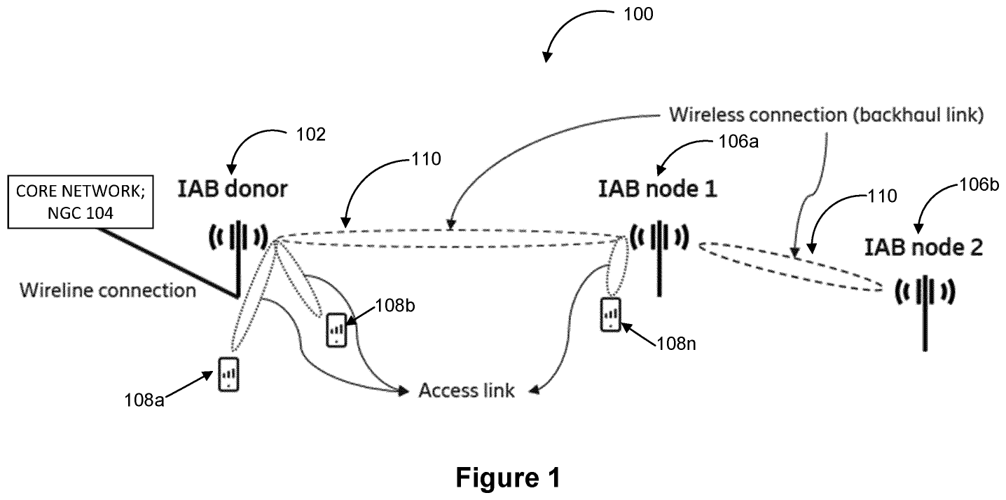

FIG. 1 is an illustration of an example of a multi-hop deployment in an integrated access and backhaul (IAB) network 100 according to some embodiments of inventive concepts. In FIG. 1, an IAB deployment that supports multiple hops is presented. The IAB-node donor or IAB-donor node 102 has a wired connection to the core network (NGC) 104 and the IAB-nodes 106a and 106b are wirelessly connected using New Radio (NR) to the IAB-donor node 102, either directly or indirectly via another IAB-node. The connection between IAB-donor node 102 and UEs 108a-108n is called an access link, whereas the connection between two IAB-nodes or between an IAB-donor node 102 and an IAB-node 106a is called backhaul link 110.

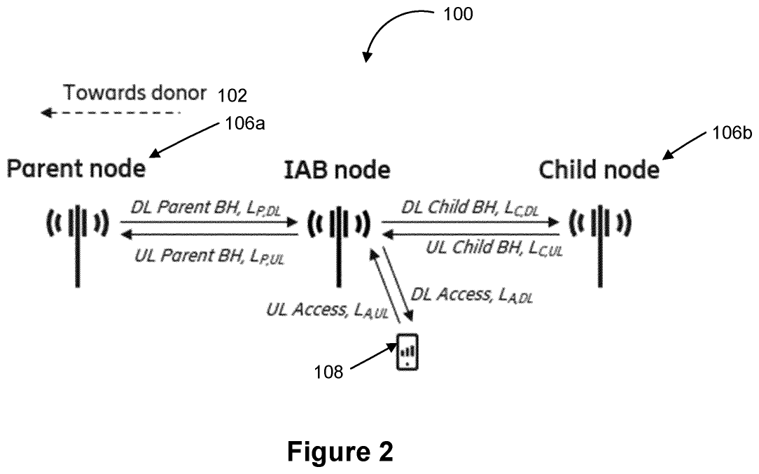

Furthermore, as shown in FIG. 2, the adjacent upstream node 106 which is closer to the IAB-donor node 102 is referred to as a parent node 106a of the IAB-node. The adjacent downstream node which is further away from the IAB-donor node 102 is referred to as a child node 106b of the IAB-node. The backhaul link between the parent node and the IAB-node is referred to as the parent (backhaul) link, whereas the backhaul link between the IAB-node and the child node is referred to as the child (backhaul) link.

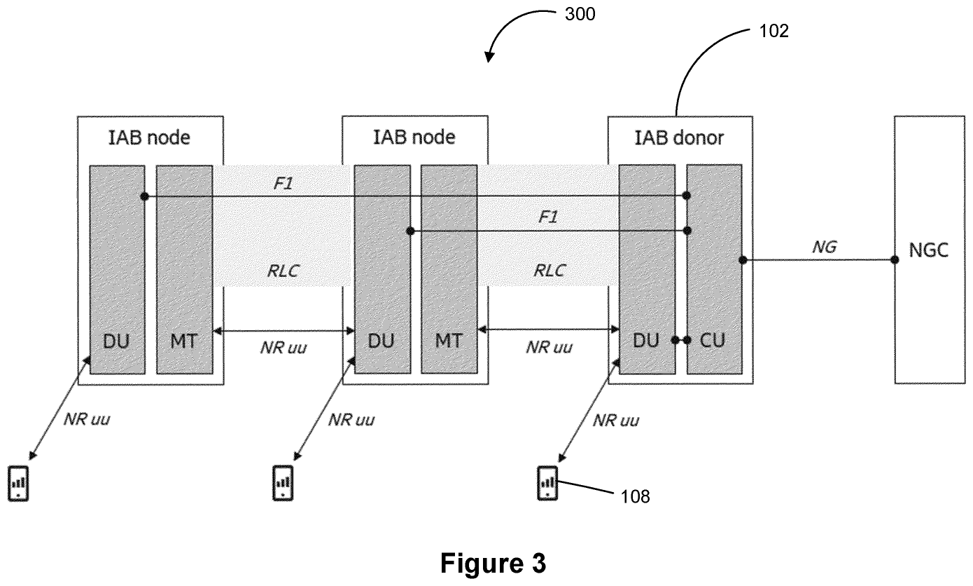

FIG. 3 is an illustration of an example of an IAB architecture 300 according to some embodiments of inventive concepts. As one major difference of the IAB architecture compared to Rel-10 LTE relay (besides lower layer differences) is that the IAB architecture 300 adopts the Central-Unit/Distributed-Unit (DU/DU) split of 5G base stations (gNBs) in which time-critical functionalities are realized in IAB-DU closer to the radio, whereas the less time-critical functionalities are pooled in the CU with the opportunity for centralization. Based on this architecture, an IAB-donor node contains both CU and DU functions. In particular, it contains all CU functions of the IAB-nodes under the same IAB-donor. Each IAB-node then hosts the DU function(s) of a gNB. In order to be able to transmit/receive wireless signals to/from the upstream IAB-node or IAB-donor node, each IAB-node has a mobile termination (MT). The MT is a logical unit providing a necessary set of UE-like functions. Via the IAB-DU, the IAB-node establishes a Radio Link Control-Channel (RLC-channel) to the UEs and/or to the MTs of the connected IAB-node(s). Via the IAB-MT, the IAB-node establishes the backhaul radio interface towards the serving IAB-node or IAB-donor. FIG. 3 shows a reference diagram for a two-hop chain of IAB-nodes under an IAB-donor node 102.

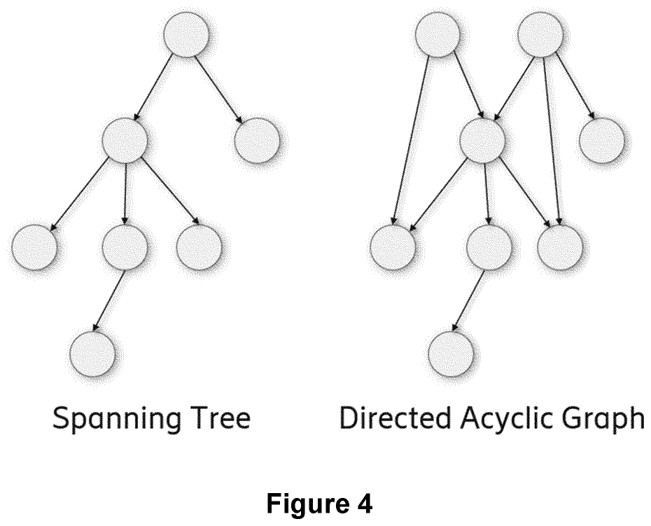

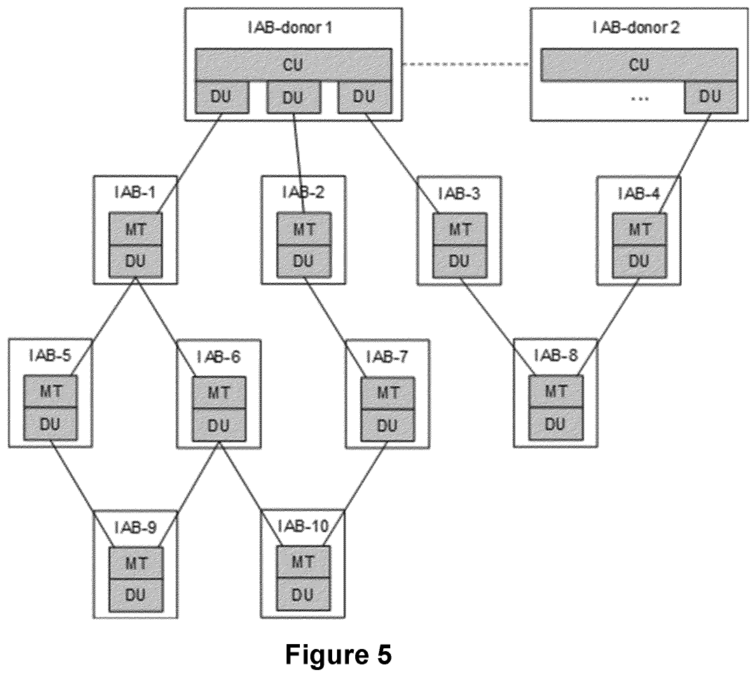

Wireless backhaul links are vulnerable to blockage, e.g., due to moving objects such as vehicles, due to seasonal changes (foliage), severe weather conditions (rain, snow or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the Rel-10 LTE relay. FIG. 4 is illustration of examples of different IAB network topologies according to some embodiments of inventive concepts. An example of a spanning tree (ST) topology IAB network and a directed acyclic graph (DAG) topology IAB network are shown in FIG. 4.

This means that one IAB-node can have multiple child nodes and/or have multiple parent IAB-nodes. Particularly regarding multi-parent topology, different scenarios may be considered as shown in FIG. 5. For example:
IAB-9 connects to IAB-donor 1 via two parent nodes IAB-5 and IAB-6 which connect to the same grandparent node IAB-1;
IAB-10 connects to IAB-donor 1 via two parent nodes IAB-6 and IAB-7 which connect to different grandparent nodes IAB-1 and IAB-2;
IAB-8 connects to two parent nodes IAB-3 and IAB-4 which connect to different IAB-donors IAB-donor 1 and IAB-donor 2.

The multi-connectivity or route redundancy may be used for back-up purposes. It is also possible that redundant routes are used concurrently, e.g., to achieve load balancing, reliability, etc. According to 3GPP TR 38.874 NR; Study on integrated access and backhaul V16.0.0, January 2019, when operating in Stand Alone-mode (SA-mode), an NR+NR dual connected IAB-node can add redundant routes by establishing an MCG-link (Master cell group) to one parent node IAB-DU and an SCG-link (Secondary cell group) to another parent node IAB-DU. The dual-connecting IAB-MT will enable the SCG link using the 3GPP TS 37.340, “Multi-connectivity,” 3GPP, V16.6.0, July 2021.

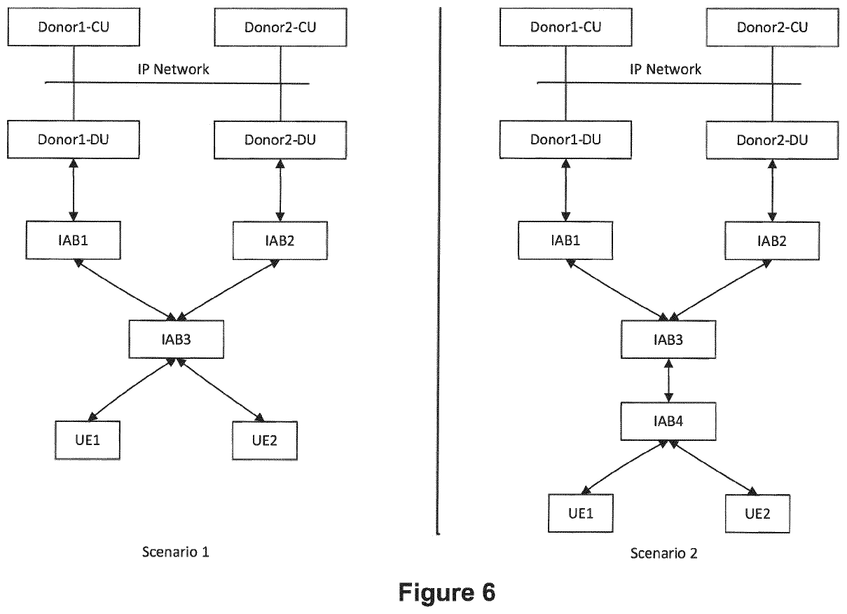

FIG. 6 is an illustration of examples of an inter-donor IAB topology according to some embodiments of inventive concepts. RAN3 has agreed the following two scenarios for the inter-donor topology redundancy:
Scenario 1: the IAB is multi-connected with 2 IAB-donors.
Scenario 2: the IAB's parent/ancestor node is multi-connected with 2 IAB-donors.

Examples of Scenario 1 and Scenario 2 are illustrated in FIG. 6.

In case of in-band operation, the IAB-node is typically subject to the half-duplex constraint, i.e., an IAB-node can only be in either transmission or reception mode at a time. Rel-16 IAB mainly considers the time-division multiplexing (TDM) case where the IAB-MT and IAB-DU resources of the same IAB-node are separated in time. Based on this consideration, the following resource types have been defined for IAB-MT and IAB-DU, respectively. From an IAB-MT point-of-view, as in Rel-15, the following time-domain resources can be indicated for the parent link:
Downlink (DL) time resource
Uplink (UL) time resource
Flexible (FL) time resource

From an IAB-node DU point-of-view, the child link has the following types of time resources:
DL time resource
UL time resource
FL time resource
Not-available (NA) time resources (resources not to be used for communication on the DU child links)

There are three ways to provide the DL/UL/FL configurations:
Semi static configuration: configured by TDD-UL-DL-ConfigurationCommon, or TDD-UL-DL-ConfigDedicated
RRC configuration: corresponding to a higher-layer configured DL symbols by for example PDCCH, PDSCH, CSI-RS etc. or UL symbols by for example SRS, PUCCH, PUSCH, PRACH
Dynamic: configured by DCI formats

Each of the downlink, uplink and flexible time-resource types of the DU child link can belong to one of two categories:
Hard (H): The corresponding time resource is always available for the DU child link
Soft (S): The availability of the corresponding time resource for the DU child link is explicitly and/or implicitly controlled by the parent IAB-node.

The IAB-DU resources are configured per cell, and the H/S/NA attributes for the IAB-DU resource configuration are explicitly indicated per-resource type (D/U/F) in each slot. As a result, the semi-static time-domain resources of the IAB-DU part can be of seven types in total: Downlink-Hard (DL-H), Downlink-Soft (DL-S), Uplink-Hard (UL-H), Uplink-Soft (UL-S), Flexible-Hard (FL-H), Flexible-Soft (FL-S), and Not-Available (NA). The coordination relation between IAB-MT and IAB-DU resources are listed in Table 1.

The IAB-DU resources are configured per cell, and the H/S/NA attributes for the IAB-DU resource configuration are explicitly indicated per-resource type (D/U/F) in each slot. As a result, the semi-static time-domain resources of the IAB-DU part can be of seven types in total: Downlink-Hard (DL-H), Downlink-Soft (DL-S), Uplink-Hard (UL-H), Uplink-Soft (UL-S), Flexible-Hard (FL-H), Flexible-Soft (FL-S), and Not-Available (NA). The coordination relation between IAB-MT and IAB-DU resources are listed in Error! Reference source not f ound.

TABLE 1

| | | IAB-MT configuration | | |
|---|---|---|---|---|
| | | DL | UL | Flexible |
| DU | DL-H | DU: can transmit on DL | DU: can transmit on DL | DU: can transmit on DL |
| configuration | | unconditionally; | unconditionally; | unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL & |
| | | | | UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL & |
| | | | | UL. |
| | F-H | DU: can transmit on DL | DU: can transmit on DL | DU: can transmit on DL |
| | | or schedule UL | or schedule UL | or schedule UL |
| | | unconditionally; | unconditionally; | unconditionally; |
| | | MT: not available. | MT: not available. | MT: not available. |
| | F-S | DU: can transmit on DL | DU: can transmit on DL | DU: can transmit on DL |
| | | or schedule UL | or schedule UL | or schedule UL |
| | | conditionally; | conditionally; | conditionally; |
| | | MT: available on DL. | MT: available on UL. | MT: available on DL & |
| | | | | UL. |
| | NA | DU: not available; | DU: not available; | DU: not available; |
| | | MT: available on DL. | MT: available on UL. | MT: available on DL & |
| | | | | UL. |

Furthermore, a DU function may correspond to multiple cells, including cells operating on different carrier frequencies. Similarly, an MT function may correspond to multiple carrier frequencies. This can either be implemented by one MT unit operating on multiple carrier frequencies, or be implemented by multiple MT units, each operating on one carrier frequency. The H/S/NA attributes for the per-cell DU resource configuration should take into account the associated MT carrier frequency or frequencies.

According to the definition, the explicitly configured Soft DU resource is by default unavailable if it is not indicated as available. There are two ways to indicate the availability from the parent JAB-node: implicit indication and explicit indication. In case of implicit indication, the JAB-node knows, via indirect means, such as lack of scheduling grant, no data available at MT, the JAB-node being capable of simultaneous DU and MT, etc., that the DU resource can be used without impacting the MTs ability to transmit/receive. In addition to such implicit means, the JAB-node may also receive explicit indication from the parent JAB-node about the availability.

In Rel-16 IAB, from the RAN1 perspective, only Inter-carrier Inter-band multi-parent operation is supported; from the RAN 3 perspective, only Intra-donor multi-parent case is supported. In Rel-17 IAB, Inter-donor multi-parent operation and Inter-carrier Intra-band operation will be specified.

In the Intra-donor multi-parent case, the single IAB-donor-CU can coordinate the usage of overlapping resources between the two-parent links, as well as the usage of overlapping resource between each parent link and the child link or links. For example, the resource coordination could be with respect to the following configuration parameters:
TDD pattern (Uplink/Downlink/Flexible) alignment between the parent links.
H/S/NA resource configuration of IAB-DU(s) and the parent IAB-DU(s)
Explicit indication of IAB-DU soft resource

Regarding the Inter-donor multi-parent case, the semi-static configurations will be provided to the IAB-node by the two IAB-donors and a coordination between the two IAB-donors will be needed.

Normally, it is assumed that the IAB-donor-CU(s) should solve the conflict of semi-static resource configurations (e.g., D/U/F and H/S/NA resource configurations) between the two parent IAB-nodes, and/or between the dual-connected IAB-node and each parent IAB-node. In addition, it is assumed that the parent IAB-node can be made aware of not only its own semi-static configurations, but also the semi-static configurations of the peer parent IAB-node, and the dual-connected IAB-node—this is because the conflict between these three configurations should be avoided.

However, in a multi-hop IAB network, the arrival time of F1 messages or configuration messages at different IAB-nodes may vary significantly depending on the number of hops to the IAB-donor-CU. If the updated configuration from the IAB-donor-CU (carried in an F1-message) is applied directly after it is received, there could be a timing misalignment in configuration execution at the two parent IAB-nodes, since the IAB-nodes may receive the configuration update messages from the IAB-donor(s) at different times.

Consequently, it may cause undesirable resource conflict between the parent IAB-nodes, or between any parent IAB-node and the dual-connected IAB-node. Unexpected collision in DL/UL directions may also generate severe interference situation. If the execution timing is unknown to the IAB-donor-CU, it means the centralized coordination may fail.

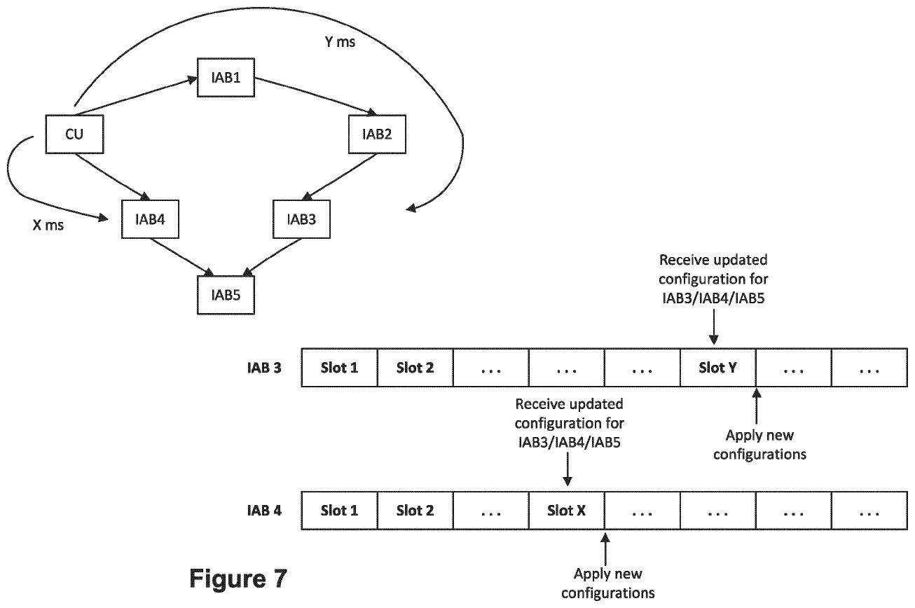

FIG. 7 is an illustration of an example of misalignment of configuration execution timing at parent IAB-nodes due to varied propagation delay and/or re-transmission between the IAB-donor-CU or IAB-donor node and each parent IAB-node according to some embodiments of inventive concepts. In the example of FIG. 7, the propagation delay between the IAB-donor-CU or IAB-donor node and the parent IAB-nodes IAB3 and IAB4 are Y milliseconds (ms) and X milliseconds (ms), respectively, where IAB3 is 3 hops from the IAB-donor-CU and IAB4 is only one hop from the IAB-donor-CU. The updated semi-static configurations will be valid at different time instances and this may cause configuration conflict which is not expected by the IAB-donor-CU.

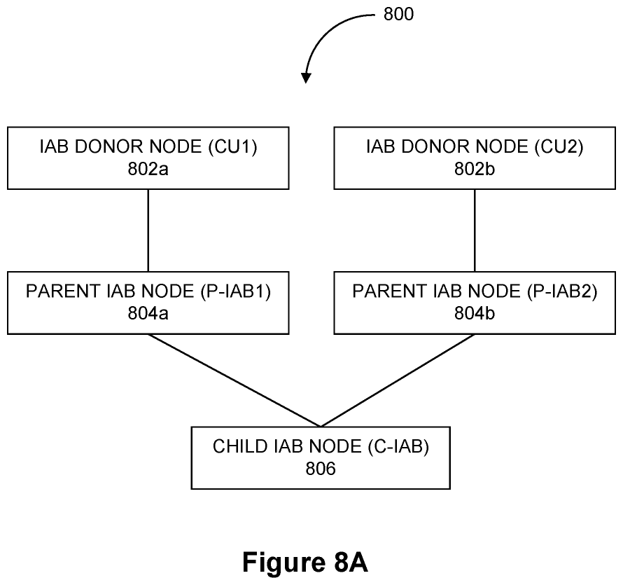

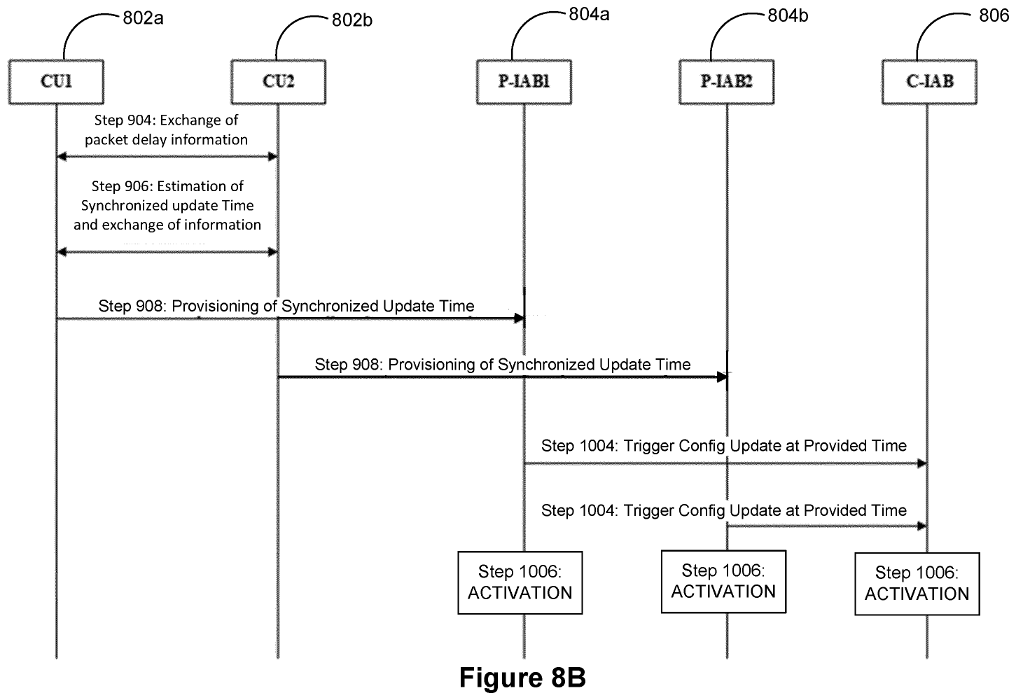

FIG. 8A is an illustration of an example of an IAB inter-donor network 800 according to some embodiments of inventive concepts. The IAB inter-donor network 800 includes a plurality of IAB-donor nodes 802a-802b and a plurality of parent IAB-nodes 804a-804b. A child IAB-node 806 is dual-connected to the plurality of parent IAB-nodes 804a-804b. The IAB inter-donor network 800 includes a first IAB-donor node 802a wirelessly linked to a first parent IAB-node 804a, and a second IAB-donor node 802b wirelessly connected to a second parent IAB-node 804b.

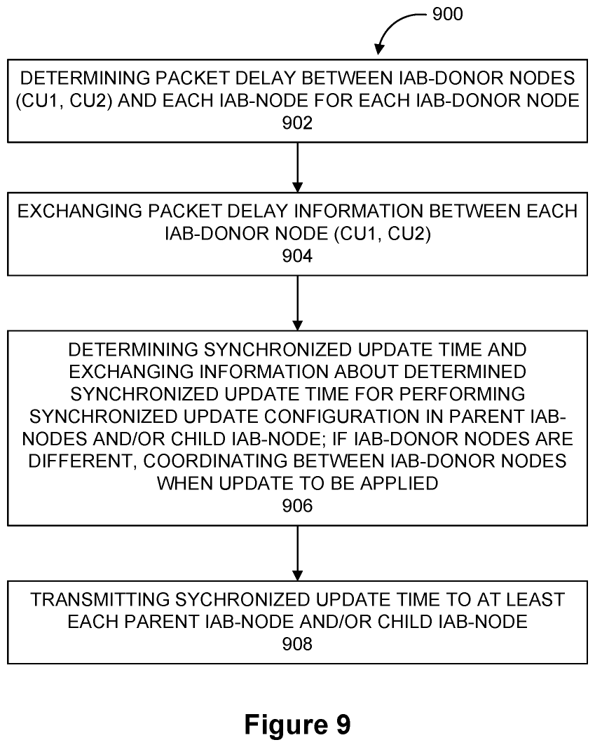

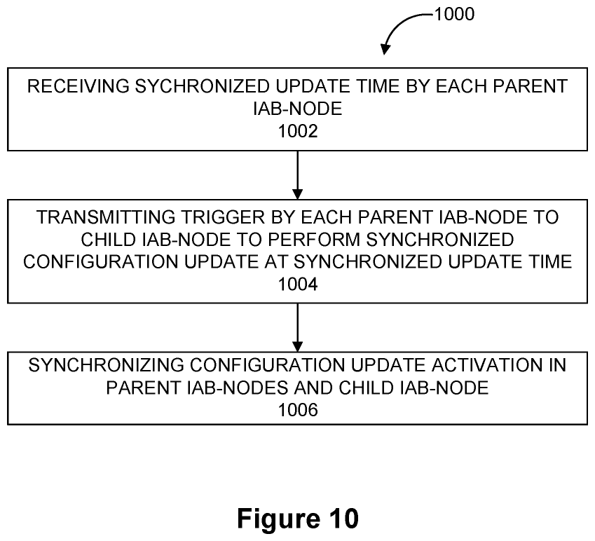

Referring also to FIG. 8B, FIG. 8B is an illustration of an example of signaling in the IAB inter-donor network 800 in FIG. 8A for performing a synchronized activation of a resource configuration in according to some embodiments of inventive concepts. In FIG. 8B, the first IAB-donor node 802a corresponds to CU1 and the second IAB-donor node 802b corresponds to CU2. The first IAB-donor node 802a corresponds to P-IAB1 and the second IAB donor-node 802b corresponds to P-IAB2 in FIG. 8A. The child IAB-node 806 corresponds to C-IAB. An example of a method 900 performed by an IAB-donor node for synchronized activation of a resource configuration will be described with reference to FIG. 9, and an example of a method 1000 performed by a parent IAB-node for synchronized activation of a resource configuration will be described with reference to FIG. 10. The steps illustrated and described with reference to FIG. 8B correspond to the blocks in FIGS. 9 and 10 for functions performed by the IAB donor-node or nodes and parent IAB-node and nodes. The steps and/or functions are also applicable to an intra-donor scenario.

For the inter-donor IAB network 800 or inter-CU case, in a step prior to Step 904, the packet delay between the IAB-donor-CUs (CU1 802a and CU2 802b) and each IAB-node 804a and 804b is estimated. Step 904 includes exchange of packet delay information between each IAB-donor-CU 802a and 802b. P-IAB1 804a and P-IAB2 804b are parent IAB-nodes of the dual-connected IAB-node C-IAB 806. P-IAB1 804a belongs to CU1 802a and P-IAB2 804b belongs to CU2 802b. In some examples, there are separate F1-AP connections such that CU1 802a has an F1AP connection for P-IAB1 804a and similarly CU2 802b has an F1-AP connection for P-IAB2 804b. In some examples, P-IAB1 804a and P-IAB2 804b are connected with their respective IAB-donor-CUs 802a and 802b based on a proxy-based solution for load balancing where the F1 termination is anchored by CU1 for P-IAB1 and the dual-connected IAB-node (C-IAB).

Step 906 includes determination of Synchronized update time and exchange of information about the determined time for performing a synchronized update among parent IAB-nodes 804a and 804b and dual-connected IAB-node 806. The time can be in the form of System Frame Number and slot number. Each IAB-donor-CU or IAB-donor node 802a and 802b knows the current cell timing of the cells belonging to different DUs and based upon the prevailing packet delay budget estimation, an activation time is determined for each IAB-node that is common from a perspective of the C-IAB 806. In case both CU1 802a and CU2 802b are not the same, Step 904 and 906 further include coordination among the IAB-donor-CUs or IAB-donor nodes 802a and 802b, wherein one IAB-donor-CU or IAB donor node takes the role of a reference IAB-donor-CU or donor node. This IAB-donor-CU determines when the configuration should be applied and informs the other IAB-donor-CU about this determination.

In Step 908, the activation time can be provided to each parent IAB-node P-IAB1 and P-IAB2 by their own IAB-donor-CU or by one IAB-donor-CU via F1AP for instance. The activation time is also referred to as the synchronized update time herein.

In Step 1004, each IAB-node (parent) provides the trigger at the indicated activation time by a mechanism such as MAC CE or DCI.

In Step 1006, the synchronized update among the parent nodes 804a and 804b and/or the dual-connected IAB-node 806 is performed or activated.

FIG. 9 is a flow chart of an example of a method 900 performed by an IAB-donor node for synchronized activation of a resource configuration according to some embodiments of inventive concepts. In some examples, the method 900 is performed in the IAB system 800 in FIGS. 8A and 8B. The method 900 is applicable in both inter-donor IAB networks and intra-donor IAB networks. In block 902, the method 900 includes determining a packet delay time between the IAB-donor node and each parent IAB-node for each IAB-donor node in an inter-donor topology. In some examples, determining the packet delay time includes determining a transmission time or latency between the IAB-donor node and each parent IAB-node. The inter-donor topology includes a first IAB-donor node wirelessly linked with a first parent IAB-node and a second IAB-donor node wirelessly linked with a second parent IAB-node.

In block 904, the method 900 includes exchanging packet delay information between the first IAB-donor node (CU1) and the second IAB-donor node (CU2).

In block 906, the method 900 includes determining, by the IAB-donor node (CU1 and/or CU2), a synchronized update time for performing a synchronized configuration update in a plurality of parent IAB-nodes and/or a child IAB-node. The child IAB-node is dual-connected to the plurality of parent IAB-nodes. In some examples, determining the synchronized update time includes determining the synchronized update time by each IAB-donor node and exchanging information between the IAB-donor nodes about the synchronized update time for performing a synchronized update configuration in the parent IAB-nodes and/or the child IAB-node. In some examples, the synchronized update time is determined by using an estimated packet delay time or transmission time between the IAB-donor node and each parent IAB-node. A relative time difference is also usable rather than the delay times for each parent.

In some examples, in block 906, the method 900 includes coordinating between the first IAB-donor node and the second IAB-donor node for determining the synchronized update time. One of the first or second IAB-donor nodes becomes a reference IAB-donor node for determining the synchronized update time. The reference IAB-donor node transmits the synchronized update time to the other of the first or second IAB-donor nodes.

In block 908, the method 900 includes transmitting, by the IAB-donor node, the synchronized update time to at least each parent IAB-node and/or the child IAB-node. In some examples, transmitting the synchronized update time includes one of:
transmitting the synchronized update time by each IAB-donor node to its associated parent IAB-node; or
transmitting the synchronized update time by one of the IAB-donor nodes to each parent IAB-node.

In some examples, transmitting the synchronized update time to each parent IAB-node includes transmitting an activation delay to each parent IAB-node before performing the synchronized configuration update. The synchronized update time includes a system frame number and a slot number.

In some examples, transmitting the synchronized update time to each parent IAB-node includes transmitting the synchronized update time in an F1 message. In some examples, the F1 message is an F1 Application Protocol (F1AP) message. In some examples, transmitting the synchronized update time includes transmitting the F1 message by a Central Unit (CU) of the IAB-donor node to a Distributed Unit (DU) of the parent IAB-node.

In some examples, the synchronized configuration update includes a configuration update for a Distributed Unit (DU) of each parent IAB-node and/or a Mobile Termination (MT) of the child IAB-node. The configuration update is applied synchronously to the DU of each parent IAB-node and/or the MT of the child IAB-node.

In some examples, transmitting the synchronized update time to each parent IAB-node to activate the synchronized configuration update comprises one of:
transmitting a specific slot, a specific symbol inside the specific time slot, or a specific frame;
transmitting a specific time, system frame number (SFN), and/or slot number; or
transmitting a delay time or activation delay after reception of a configuration message by the parent IAB-node before activating the configuration update.

The synchronized update time or the activation delay are provided as a new information element in an existing F1 message for a gNB-DU resource configuration or in another F1 message.

In some examples, transmitting, by the IAB-donor node, the synchronized update time includes transmitting the synchronized update time or alignment information to the child IAB-node and each of the parent IAB-nodes in separate messages. The message from the IAB-donor node to the child IAB-node includes an F1 message or a Radio Resource Control (RRC) message.

FIG. 10 is a flow chart of an example of a method 1000 performed by a parent IAB-node for synchronized activation of a resource configuration according to some embodiments of inventive concepts. In block 1002, the method 1000 includes receiving, by the parent IAB-node, a synchronized update time for performing a synchronized configuration update from an IAB-donor node.

In block 1004, the method 1000 includes transmitting, by the parent IAB-node, a trigger to a child IAB-node to perform the synchronized configuration update at the synchronized update time. In some examples, transmitting the trigger to the child IAB-node includes transmitting one of a Medium Access Control-Control Element (MAC-CE) message, a Downlink Control Indicator (DCI) message, or a Backhaul Adaption Protocol (BAP) control Protocol Data Unit (PDU).

In block 1006, the method includes synchronizing configuration update activation in the parent IAB-nodes and the child IAB-node.

In some examples, the method 1000 includes receiving, by the parent IAB-node, a UE-associated F1 message including activation timing information for performing the synchronized configuration update from the IAB-donor node. The method 1000 also includes transmitting, by the parent IAB-node, the activation timing information to the child IAB-node in a BAP control PDU.

In some examples, the method 1000 also includes receiving, by the parent IAB-node, a plurality of configurations before activation of any of the configurations based on the synchronized update time or an activation delay for each configuration. Each configuration is received at a different time slot. The parent IAB-node activates each configuration according to its synchronized update time or activation delay, or the parent IAB-node activates a latest received configuration with an earliest synchronized update time or activation delay and ignores all earlier received configurations with a later synchronized update time or activation delay.

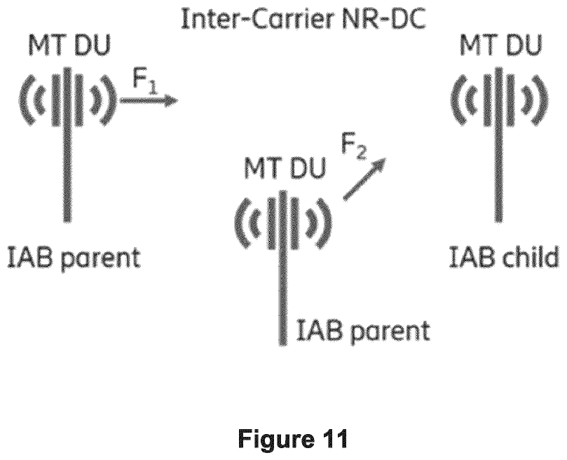

FIG. 11 is an example of IAB network including inter-carrier New Radio-Dual Connectivity (NR-DC) according to some embodiments of inventive concepts. When operating in SA-mode, an NR+NR dual connected IAB-node can add redundant routes by establishing an MCG-link to one parent node IAB-DU and an SCG-link to another parent node IAB-DU. The dual-connecting IAB-MT will enable the SCG link using the Rel-15 NR-DC procedures. As described in TS 37.340 [3], NR+NR dual connectivity is a Multi-Radio Dual Connectivity (MR-DC) configuration with the 5GC. In MR-DC, two or more Component Carriers (CCs) may be aggregated over two cell groups.

The invention consists of two aspects for intra-donor topology (i.e., IAB-node served by two or more parents under the same IAB-donors).
a) How IAB-donor-CU determines the activation time required for each IAB-node.
b) How each parent IAB-node provides the update command to dual-connected IAB-node, in a way synchronized with the provision of the command to the node by the other parent.

The invention consists of three aspects for inter-donor topology (i.e., IAB-node served by two or more parents under different IAB-donors).
a) Exchange of information between two IAB-donor-CUs with regards to which IAB-donor-CU will generate the activation time and provide the information to each parent node
b) How IAB-donor-CU determines the activation time of the command pertaining for each IAB-node.
c) How each parent IAB-node provides the synchronized update command to dual-connected IAB-node.

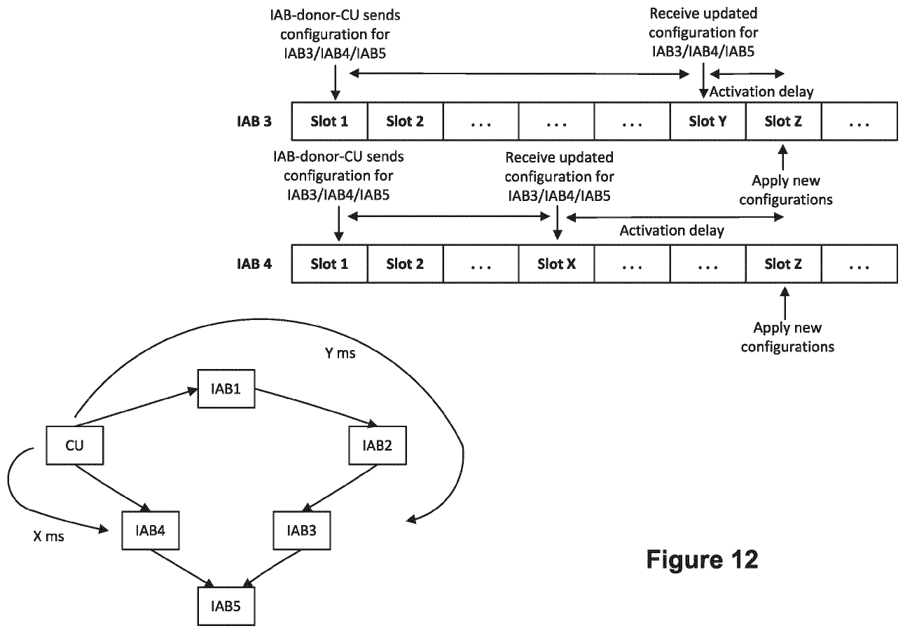

FIG. 12 is an illustration of an example of synchronized activation of a resource configuration in an IAB network according to some embodiments of inventive concepts. FIG. 12 is an illustration of a Method 1: Alignment of activation timing at parent DUs by explicit indication. As previously described, the configurations to be activated consist of the configuration for parent IAB-DUs and configurations for dual-connected IAB-MT, and they all need to be applied at the same time. The IAB-donor-CU or IAB-donor node can control the execution time of the updated configurations by providing a specific activation timing in the F1 message that it sends to the parent IAB-nodes. In general, the time necessary for a message from the IAB-donor-CU to reach the two parents will be different. One way to solve the two parents receiving the message at different times is to explicitly indicate to each parent DU the exact time when the configuration is to be applied. The aligned activation timing is determined considering the estimated packet delay information of both IAB-nodes.

As explained above, due to different delays from the IAB-donor to the two parents, when the IAB-donor-CU sends the F1 configuration messages to the two parent IAB-nodes, the messages will arrive at the parent IAB-nodes at different times. However, if the IAB-donor-CU explicitly indicates to the parent nodes the time when the configurations are to be activated, this will ensure the execution timing is aligned at the two parent IAB-nodes.

FIG. 12 shows an example that the IAB-donor-CU transmits the updated configurations to the two parent IAB-nodes of IAB5, namely IAB3 and IAB4, at the same time instant. Due to different propagation delay the messages will arrive at the two parent IAB-nodes at different time instances, Slot Y and Slot X, respectively. There are at least a few ways to achieve the alignment in this case:
In one embodiment, since the Time Division Duplex (TDD) slot boundaries and slot numbers are aligned at the parent IAB-DUs (and throughout the IAB network), IAB-donor-CU can indicate to the two parent DUs to activate the configurations at a specific slot, e.g., Slot Z in FIG. 10. Alternatively, the IAB-donor-CU can indicate a specific symbol inside a specific timeslot or a specific frame when the configuration should be activated.
In another embodiment, the configuration activation time can be expressed as an explicit time (e.g., with respect to a time reference, SFN and/or slot number).
In another embodiment, by knowing the propagation delay towards both parent DUs, IAB-donor-CU can indicate to each parent IAB-DU after how much time after the reception of the message it should activate the configuration (this is referred to as the activation delay in FIG. 12, or wait time, and it is different for the two parents).

In some embodiments, the configuration activation time or activation delay can be provided as a new information element in the existing F1 message for gNB-DU resource configuration, or in another F1-messages, existing or newly defined.

In some embodiments, the parent IAB-node will in one F1-message receive its own semi-static configuration and also the semi-static configurations of the peer-parent IAB-node and the dual-connected IAB-node.

In some embodiments, the F1 message delivering the information pertaining to only one child of the parent DU can be a UE-associated F1 message. In other embodiments, the message can carry information pertaining to multiple children of the parent DU, for which the configuration is to be updated, and in this case the non-UE-associated message is used.

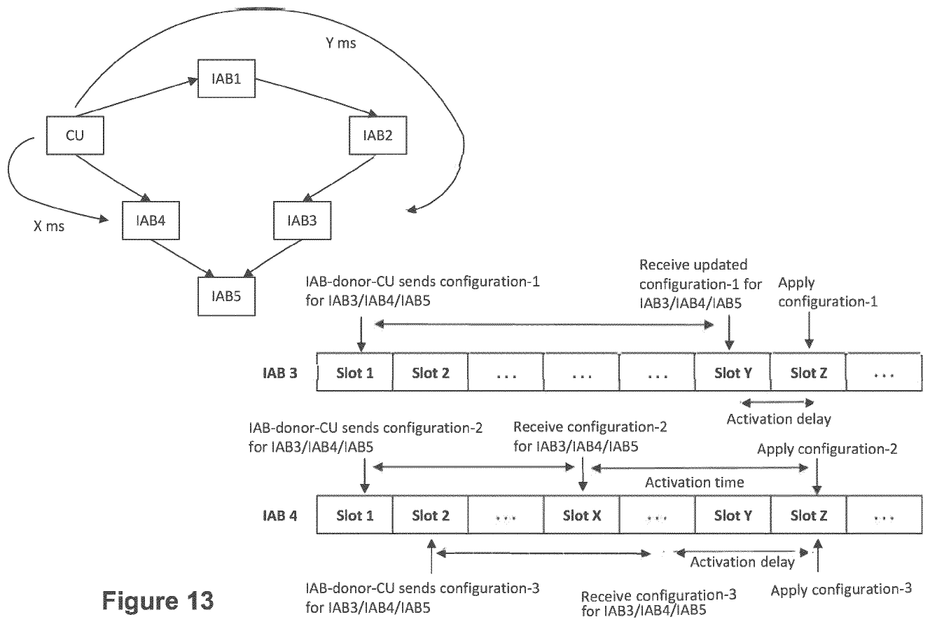

FIG. 13 is an illustration of another example of synchronized activation of a resource configuration in an IAB network according to some embodiments of inventive concepts. In some examples, a parent-node may receive more than one configuration (from the IAB-donor-CU) before any of them are activated. As illustrated in FIG. 13, the parent-node IAB4 has first received configuration-2 which will be activated at Slot Z and later received configuration-3 which will be activated at Slot Y where Slot Y is earlier than Slot Z. In this case, the parent-node IAB4 can first activate the later received configuration-3 at Slot Y and then activate the earlier received configuration-2 at Slot Z. In an alternate embodiment, the parent-node IAB4 can disregard the first received configuration-2 and directly apply the later received configuration-3. In other words, the parent-node IAB-4 can disregard the configuration with highest slot number (Slot Z in FIG. 13) and only apply the configuration which is closest in time (Slot Y in FIG. 13).

In one embodiment regarding the inter-donor case, one IAB-donor-CU takes the role of a reference IAB-donor-CU, determining when the configuration should be applied. The reference IAB-donor-CU informs the other IAB-donor-CU about the activation timing and each IAB-donor-CU includes the activation time in the F1 message.

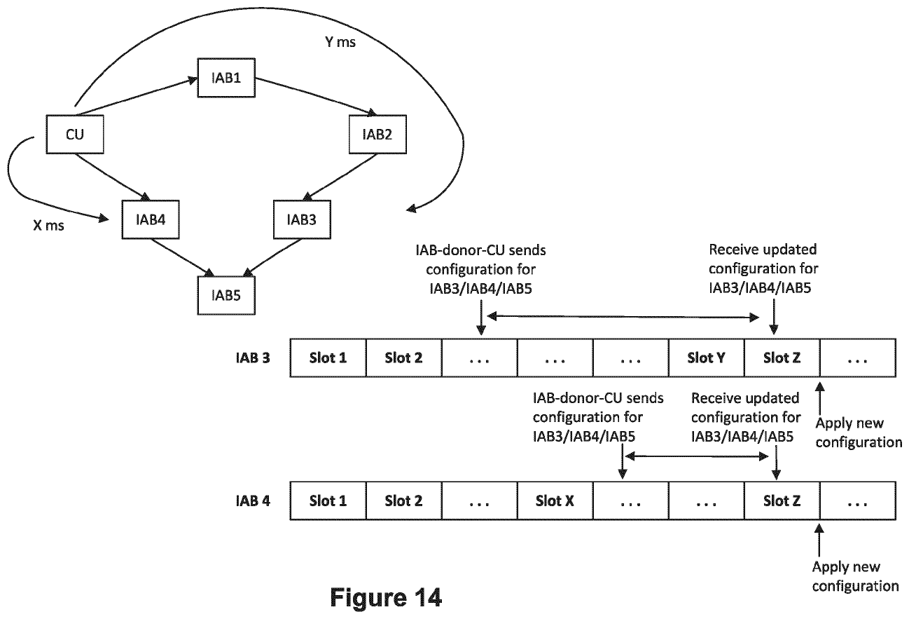

FIG. 14 is an illustration of another example of synchronized activation of a resource configuration in an IAB network according to some embodiments of inventive concepts. FIG. 14 illustrated an example of a Method 2: Alignment of activation timing at parent DUs by an IAB-donor-CU sending the messages to the parent DUs at different times. The IAB-donor-CU can also control the execution timing of the updated resource configuration by selecting the transmission timing of the F1 message. Based on an estimation of the packet delay information, the IAB-donor-CU may also send the F1 configuration messages to the two parent IAB-nodes at different time to ensure the configurations are received at the same time at the two parent IAB-nodes. FIG. 14 shows an example based on Method 2 that the IAB-donor-CU transmits the updated configurations to the two parent IAB-nodes at different time instant, based on the respective packet delay information. Accordingly, the F1 messages will arrive at the two parent IAB-nodes at the same time instant and will be valid with an aligned execution timing.

In one embodiment regarding the inter-donor case, one IAB-donor-CU takes the role of a reference IAB-donor-CU, determining when the resource configuration should be applied. The reference IAB-donor-CU informs the other IAB-donor-CU about the activation time and each IAB-donor-CU determines the transmission timing based on the planned activation time and packet delay to the respective parent IAB-node.

FIG. 14 illustrates an example of a method performed by an integrated access and backhaul (IAB) donor node for synchronized activation of a resource configuration, the method includes determining, by the IAB-donor node, a respective packet delay time between the IAB-donor node and each parent IAB-node of a plurality of parent IAB-nodes, wherein a child IAB-node is dual-connected to each of the parent IAB-nodes. The method also includes transmitting, by the IAB-donor node, a configuration message to at least each parent IAB-node of the plurality of parent IAB-nodes at a different time based on the respective packet delay time or transmission time between the IAB donor and each parent IAB-node to cause each configuration message to be received by each of the parent IAB-nodes at a same time. The configuration message includes a configuration update for synchronized activation by each parent IAB-node and/or the child IAB-node. As previously described, in some examples, the configuration message includes an F1 message. Additionally, in an inter-donor topology which includes a first IAB-donor node and a second IAB-donor node, one of the first or second IAB-donor nodes becomes a reference IAB-donor node and determines a synchronized update time to perform the configuration update. The reference IAB-donor node informs another of the first or second IAB-donor nodes of the synchronized update time, and each IAB-donor node determines a transmission time for transmitting the configuration message based on the synchronized update time and the respective packet delay time between each IAB-donor node and a respective parent IAB-node.

The synchronized configuration update can be referred as activation time based upon System frame number and slot number as indicated below. The activation time can also be considered as a delay (wait timer); time until the IAB-node need to wait before applying the configuration.

| | |
|---|---|
| System Frame Number | INTEGER(0 . . . 1023) |
| Slot Number | INTEGER(0 . . . 79) |

In one embodiment, IAB-donor-CU can indicate a specific symbol in a specific slot as the activation time. In one embodiment, the activation time can also be termed as wait time, as how long each IAB-node needs to wait before triggering the update of the configuration. Activation time can also be provided in terms of time units such as absolute time in terms of milliseconds or relative time with respect to a UTC time reference.

The IAB-donor-CU takes into account the current cell timing of all the cells involved. Further, the packet delay budget associated for a packet to traverse through multiple IAB-nodes and to reach to the destined IAB-node from multiple parent's paths is also computed by the IAB-donor-CU. Based upon this the activation time is determined. The packet delay associated with user plane can also be used as a reference to deduce the control plane delay.

The activation time that is provided can also be associated to a certain route/path-ID as it would be dependent upon packet delay budget which depends upon which route the packet traverses.

The activation time can be provided by F1AP (TS 38.473 v 16.4.0), the enhancements of an existing F1 message which includes a configuration activation time, a system frame number, a slot number and/or a symbol number inside the slot.

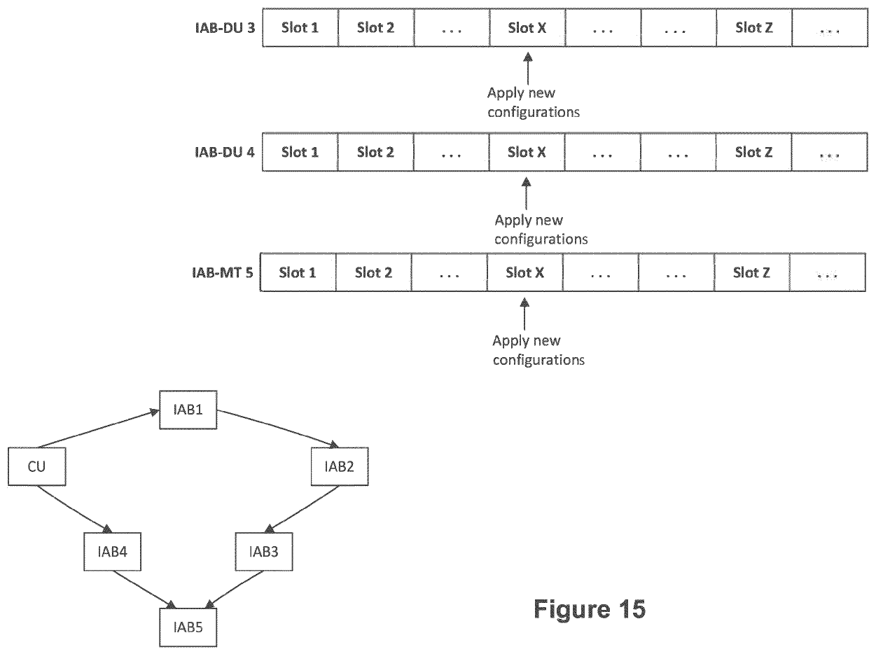

FIG. 15 is an illustration of a further example of synchronized activation of a resource configuration in an IAB network according to some embodiments of inventive concepts. FIG. 15 illustrates an example of aligning or synchronizing the activation timing of a synchronized configuration update at an IAB-MT or child IAB node with the activation time at the parent DUs or parent IAB nodes. There are several ways to deliver the activation time/trigger to the IAB-node. As illustrated in FIG. 15, there is also a need to synchronize the activation timing of resource configurations for parent IAB-DUs and dual-connected IAB-MT, for example parent IAB-DU DL transmission should be aligned to IAB-MT DL reception, or parent IAB-DU UL reception should be aligned to IAB-MT UL transmission.

In one embodiment, the IAB-donor-CU or IAB-donor node sends the alignment info including a synchronized update time to both the IAB-node or child IAB-node and the two parent IAB-DUs, in separate messages. The delivery to the IAB-node can be either via F1AP or via Radio Resource Control (RRC) from IAB-donor-CU to IAB-node. In this case, the F1AP or RRC message sent from IAB-donor-CU to IAB-node is associated to the same parent IAB-DU semi-static resource configuration as the activation timing. In one embodiment, it is the parent DUs that send the activation timing to the dual-connected IAB-node on the associated IAB-MT resource configuration, in one of the ways described below.

MAC CE-Based Indication to IAB-Node from Parent DU

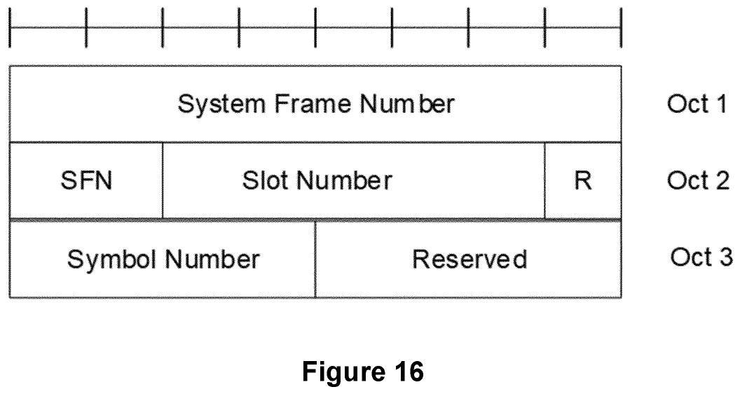

In some embodiments, based on the activation timing in the F1-message, the parent IAB-nodes can inform the dual-connected IAB-MT about the activation timing of the updated semi-static configurations by sending a synchronization command in a Medium Access Control-Control Element (MAC-CE) message. A MAC PDU with a subheader and MAC control element for IAB is designed with a new logical LCID or e-LCID reserved for IAB purpose. Either the (e)LCID or one of the fields from the subheader is used to denote that the MAC CE contains the activation time. FIG. 16 is an example of MAC CE signaling according to some examples of inventive concepts.

DCI-Based Indication to IAB-Node from Parent DU

In some embodiments, based on the activation timing in the F1-message, the parent IAB-nodes can inform the dual-connected IAB-MT about the activation timing of the updated semi-static configurations by sending a synchronization command in a DCI (Downlink Control Indicator) message. This DCI could contain activation time information with respect to System Frame Number (SFN), slot number, symbol number or activation delay in seconds (microseconds).

BAP-Based Indication to IAB-Node from Parent DU

In some embodiments, the parent IAB-nodes can inform the dual-connected IAB-MT about the activation timing of the updated semi-static configurations by sending a synchronization command in a Backhaul Adaption Protocol (BAP) control Protocol Data Unit (PDU), sent from a parent IAB-node to the IAB-node or child IAB-node. Namely, the IAB-donor-CU can send to the parent IAB-node a UE-associated F1 message carrying the activation timing, and the parent node extracts the activation time from the F1 message and delivers the activation timing information to the child IAB-node via a BAP control PDU. The informational content of the BAP control PDU can be similar to what was previously described in the F1 message to parent DU.

An advantage with respect to the delivery via a RRC message is that the RRC message is carried to the parent node inside an F1 message, which may be referred to as RRC message A, and, upon extraction at the parent, the message needs to be buffered at the parent node for a certain period. If, within that period, a new RRC message, which may be referred to as RRC message B, pertaining to the child IAB-node arrives at the parent IAB-node, problems can arise because the RRC messages must follow a strict order of delivery to the MT, so the RRC message B may be urgent but will have to wait to be delivered to the IAB-node because it could not be delivered to the IAB-node before RRC message A. This is because each RRC message is assigned a Packet Data Convergence Protocol (PDCP) sequence number, and the MT shall apply the RRC messages received in the order of PDCP sequence number. On the other hand, for delivery between parent and child inside a BAP control PDU, if the activation timing is carried as an explicit information element inside the F1 message from IAB-donor-CU to the parent, it can be extracted by the parent and delivered to the IAB-node at the designated time, and then inserted into the BAP control PDU and sent to the child IAB-node, without having to consider the arrivals of subsequent F1 messages encapsulating RRC messages for the child IAB-node. The above can be implemented in a newly defined BAP control PDU or can be included in an existing BAP control PDU, defined in TS 38.340. The BAP control PDU can be implemented in a newly defined BAP control PDU or can be included in an existing BAP control PDU, defined in TS 38.340.

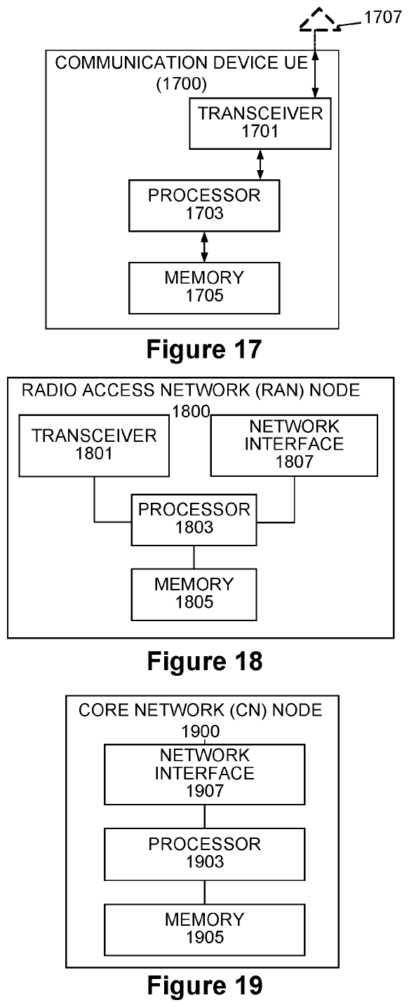

FIG. 17 is a block diagram illustrating elements of a communication device UE 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 1700 may be provided, for example, as discussed below with respect to wireless devices UE QQ112A, UE QQ112B, and wired or wireless devices UE QQ112C, UE QQ112D of FIG. QQ1, UE QQ200 of FIG. QQ2, virtualization hardware QQ504 and virtual machines QQ508A, QQ508B of FIG. QQ5, and UE QQ606 of FIG. QQ6, all of which should be considered interchangeable in the examples and embodiments described herein and be within the intended scope of this disclosure, unless otherwise noted.) As shown, communication device UE may include an antenna 1707 (e.g., corresponding to antenna QQ222 of FIG. QQ2), and transceiver circuitry 1701 (also referred to as a transceiver, e.g., corresponding to interface QQ212 of FIG. QQ2 having transmitter QQ218 and receiver QQ220) including a transmitter and a receiver configured to provide uplink and downlink radio communications with a base station(s) (e.g., corresponding to network node QQ110A, QQ110B of FIG. QQ1, network node QQ300 of FIG. QQ3, and network node QQ604 of FIG. QQ6 also referred to as a RAN node) of a radio access network. Communication device UE may also include processing circuitry 1703 (also referred to as a processor, e.g., corresponding to processing circuitry QQ202 of FIG. QQ2, and control system QQ512 of FIG. QQ5) coupled to the transceiver circuitry, and memory circuitry 605 (also referred to as memory, e.g., corresponding to memory QQ210 of FIG. QQ1) coupled to the processing circuitry. The memory circuitry 1705 may include computer readable program code that when executed by the processing circuitry 1703 causes the processing circuitry to perform operations according to embodiments disclosed herein. According to other embodiments, processing circuitry 1703 may be defined to include memory so that separate memory circuitry is not required. Communication device UE may also include an interface (such as a user interface) coupled with processing circuitry 1703, and/or communication device UE may be incorporated in a vehicle.

As discussed herein, operations of communication device UE may be performed by processing circuitry 1703 and/or transceiver circuitry 1701. For example, processing circuitry 1703 may control transceiver circuitry 1701 to transmit communications through transceiver circuitry 1701 over a radio interface to a radio access network node (also referred to as a base station) and/or to receive communications through transceiver circuitry 1701 from a RAN node over a radio interface. Moreover, modules may be stored in memory circuitry 1705, and these modules may provide instructions so that when instructions of a module are executed by processing circuitry 1703, processing circuitry 1703 performs respective operations (e.g., operations discussed below with respect to Example Embodiments relating to wireless communication devices). According to some embodiments, a communication device UE 1700 and/or an element(s)/function(s) thereof may be embodied as a virtual node/nodes and/or a virtual machine/machines.

FIG. 18 is a block diagram illustrating elements of a radio access network RAN node 1800 (also referred to as a network node, base station, eNodeB/eNB, gNodeB/gNB, etc.) of a Radio Access Network (RAN) configured to provide cellular communication according to embodiments of inventive concepts. (RAN node 1800 may be provided, for example, as discussed below with respect to network node QQ110A, QQ110B of FIG. QQ1, network node QQ300 of FIG. QQ3, hardware QQ504 or virtual machine QQ508A, QQ508B of FIG. QQ5, and/or base station QQ604 of FIG. QQ6, all of which should be considered interchangeable in the examples and embodiments described herein and be within the intended scope of this disclosure, unless otherwise noted.) As shown, the RAN node may include transceiver circuitry 701 (also referred to as a transceiver, e.g., corresponding to portions of RF transceiver circuitry QQ312 and radio front end circuitry QQ318 of FIG. QQ3) including a transmitter and a receiver configured to provide uplink and downlink radio communications with mobile terminals. The RAN node may include network interface circuitry 1807 (also referred to as a network interface, e.g., corresponding to portions of communication interface QQ306 of FIG. QQ3) configured to provide communications with other nodes (e.g., with other base stations) of the RAN and/or core network CN. The network node may also include processing circuitry 1803 (also referred to as a processor, e.g., corresponding to processing circuitry QQ302 of FIG. QQ3) coupled to the transceiver circuitry, and memory circuitry 1805 (also referred to as memory, e.g., corresponding to memory QQ304 of FIG. QQ3) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that a separate memory circuitry is not required.

As discussed herein, operations of the RAN node may be performed by processing circuitry 1803, network interface 1807, and/or transceiver 1801. For example, processing circuitry 1803 may control transceiver 1801 to transmit downlink communications through transceiver 1801 over a radio interface to one or more mobile terminals UEs and/or to receive uplink communications through transceiver 1801 from one or more mobile terminals UEs over a radio interface. Similarly, processing circuitry 1803 may control network interface 1807 to transmit communications through network interface 1807 to one or more other network nodes and/or to receive communications through network interface from one or more other network nodes. Moreover, modules may be stored in memory 1805, and these modules may provide instructions so that when instructions of a module are executed by processing circuitry 1803, processing circuitry 1803 performs respective operations (e.g., operations discussed below with respect to Example Embodiments relating to RAN nodes). According to some embodiments, RAN node 1800 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

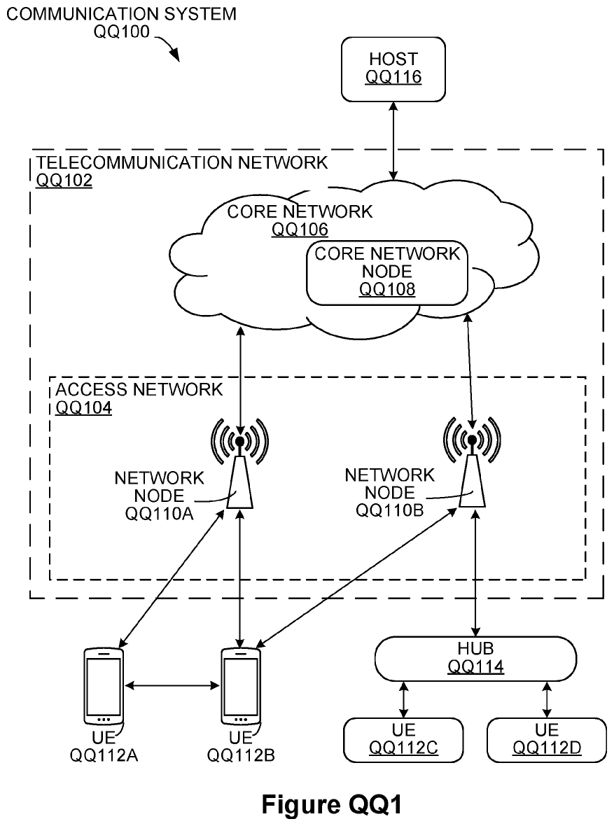

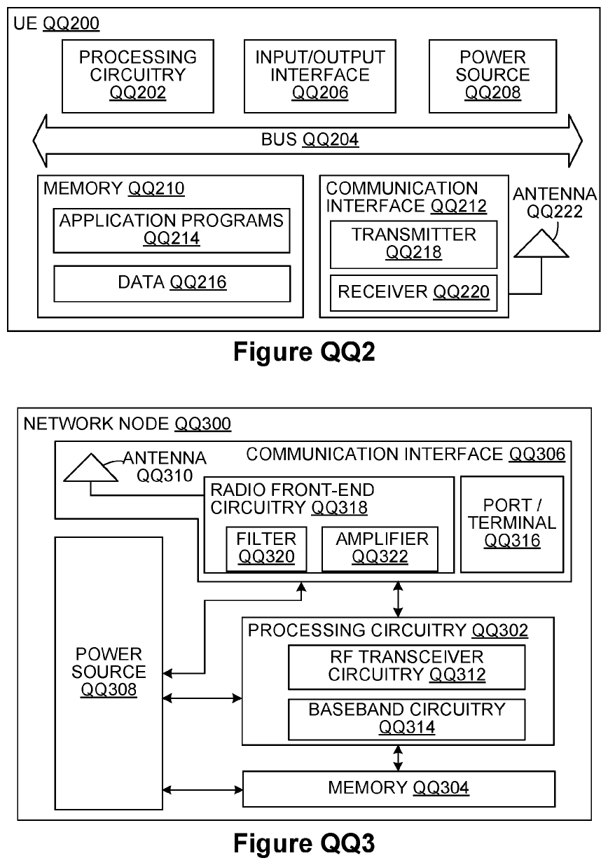

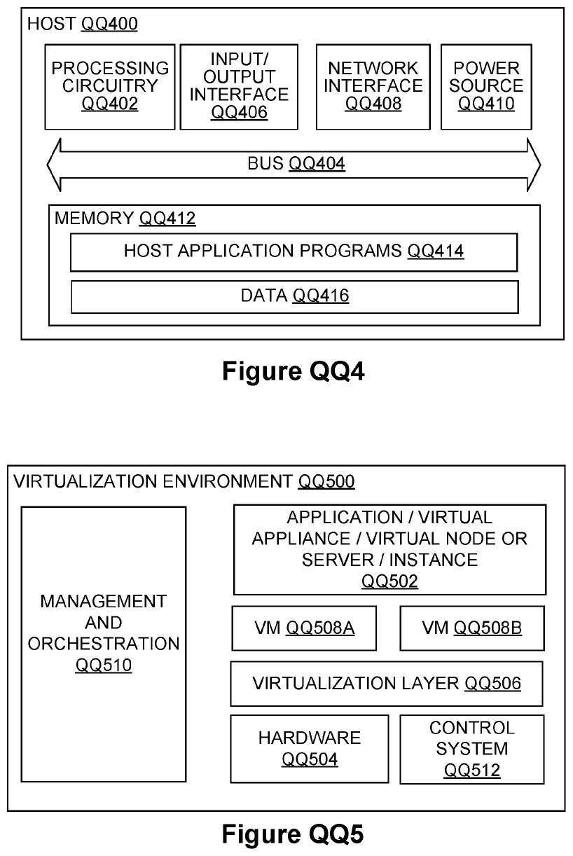

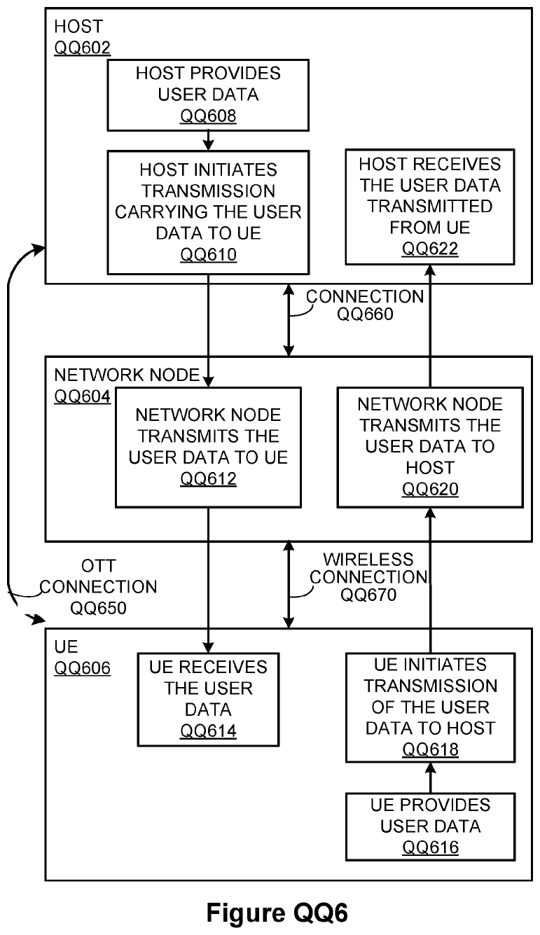

FIG. 19 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 1900 may be provided, for example, as discussed below with respect to core network node QQ108 of FIG. QQ1, hardware QQ504 or virtual machine QQ508A, QQ508B of FIG. QQ5, all of which should be considered interchangeable in the examples and embodiments described herein and be within the intended scope of this disclosure, unless otherwise noted) As shown, the CN node may include network interface circuitry 1907 configured to provide communications with other nodes of the core network and/or the radio access network RAN. The CN node may also include a processing circuitry 1903 (also referred to as a processor) coupled to the network interface circuitry, and memory circuitry 1905 (also referred to as memory) coupled to the processing circuitry. The memory circuitry 1905 may include computer readable program code that when executed by the processing circuitry 1903 causes the processing circuitry to perform operations according to embodiments disclosed herein. According to other embodiments, processing circuitry 1903 may be defined to include memory so that a separate memory circuitry is not required.

As discussed herein, operations of the CN node may be performed by processing circuitry 1903 and/or network interface circuitry 1907. For example, processing circuitry 1903 may control network interface circuitry 1907 to transmit communications through network interface circuitry 1907 to one or more other network nodes and/or to receive communications through network interface circuitry from one or more other network nodes. Moreover, modules may be stored in memory 1905, and these modules may provide instructions so that when instructions of a module are executed by processing circuitry 1903, processing circuitry 1903 performs respective operations (e.g., operations discussed below with respect to Example Embodiments relating to core network nodes). According to some embodiments, CN node 1900 and/or an element(s)/function(s) thereof may be embodied as a virtual node/nodes and/or a virtual machine/machines.

In the description that follows, while the communication device may be any of the communication device 1700, wireless device QQ112A, QQ112B, wired or wireless devices UE QQ112C, UE QQ112D, UE QQ200, virtualization hardware QQ504, virtual machines QQ508A, QQ508B, or UE QQ606, the communication device 1700 shall be used to describe the functionality of the operations of the communication device.

In the description that follows, while the network node may be any of the RAN node 700, network node QQ110A, QQ110B, QQ300, QQ606, hardware QQ504, or virtual machine QQ508A, QQ508B, the RAN node 1800 shall be used to describe the functionality of the operations of the network node. In some embodiments, the RAN node 1800 (implemented using the structure of FIG. 18) is configured to perform any of the methods 800 and 900 in the flow charts of FIGS. 8 and 9 according to some embodiments of inventive concepts. For example, modules may be stored in memory 1805 of FIG. 18, and these modules may provide instructions so that when the instructions of a module are executed by respective RAN node processing circuitry 1803, processing circuitry 1803 performs respective operations of the flow chart.

Various operations from the flow chart of FIG. 8 and FIG. 9 may be optional with respect to some embodiments of RAN nodes and related methods.

In the description that follows, while the core network node may be any of the core network node 1900, core network node QQ108, hardware QQ504, or virtual machine QQ508A, QQ508B, the core network node 1900 shall be used to describe the functionality of the operations of the network node. In some examples, the Core Network CN node 1900 is configured to perform any of the methods 800 and 900 in the flow charts of FIGS. 8 and 9 according to some embodiments of inventive concepts. For example, modules may be stored in memory 1905 of FIG. 19, and these modules may provide instructions so that when the instructions of a module are executed by respective CN node processing circuitry 1903, processing circuitry 1903 performs respective operations of the flow chart.

Various operations from the flow chart of FIGS. 8 and 9 may be optional with respect to some embodiments of CN nodes and related methods.

FIG. QQ1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. QQ2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. QQ3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. QQ4 is a block diagram of a host QQ400, which may be an embodiment of the host QQ116 of FIG. QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset, or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. QQ5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. QQ6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. QQ1 and/or UE QQ200 of FIG. QQ2), network node (such as network node QQ110a of FIG. QQ1 and/or network node QQ300 of FIG. QQ3), and host (such as host QQ116 of FIG. QQ1 and/or host QQ400 of FIG. QQ4) discussed in the preceding paragraphs will now be described with reference to FIG. QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

### EMBODIMENTS

### Group A Embodiments

1. A method performed by an integrated access and backhaul (IAB) donor node for synchronized activation of a resource configuration, the method comprising:
determining, by the IAB-donor node, a synchronized update time for performing a synchronized configuration update in a plurality of parent IAB-nodes and/or a child IAB-node, wherein the child IAB-node is dual-connected to the plurality of parent IAB-nodes; and
transmitting, by the IAB-donor node, the synchronized update time to at least each parent IAB-node and/or the child IAB-node.

2. The method of embodiment 1, wherein the synchronized update time is determined by using an estimated packet delay time or transmission time between the IAB-donor node and each parent IAB-node.

3. The method of embodiment 1, further comprising estimating a packet delay time or transmission time between the IAB-donor node and each parent IAB-node for each IAB-donor node in an inter-donor topology, wherein the inter-donor topology comprises a first IAB-donor node wirelessly linked with a first parent IAB-node and a second IAB-donor node wirelessly linked with a second parent IAB-node.

4. The method of embodiment 3, further comprising exchanging packet delay information between the first IAB-donor node and the second IAB-donor node.

5. The method of embodiment 4, wherein determining the synchronized update time comprises determining the synchronized update time by each IAB-donor node, and the method further comprises exchanging information between the IAB-donor nodes about the synchronized update time for performing a synchronized update configuration in the parent IAB-nodes and the child IAB-node.

6. The method of any of embodiments 3-5, further comprising coordinating between the first IAB-donor node and the second IAB-donor node for determining the synchronized update time.

7. The method of embodiment 6, wherein one of the first or second IAB-donor nodes becomes a reference IAB-donor node for determining the synchronized update time, and wherein the reference IAB-donor node transmits the synchronized update time to the other of the first or second IAB-donor nodes.

8. The method of any of embodiments 3-7, wherein transmitting the synchronized update time comprises one of:
transmitting the synchronized update time by each IAB-donor node to its associated parent IAB-node; or
transmitting the synchronized update time by one of the IAB-donor nodes to each parent IAB-node.

9. The method of any of the previous embodiments, wherein transmitting the synchronized update time to each parent IAB-node comprises transmitting an activation delay to each parent IAB-node before performing the synchronized configuration update.

10. The method of any of the previous embodiments, wherein the synchronized update time comprises a system frame number and a slot number.

11. The method of any of the previous embodiments, wherein transmitting the synchronized update time to each parent IAB-node comprises transmitting the synchronized update time in an F1 Application Protocol (F1AP) message.

12. The method of embodiment 11, wherein transmitting the synchronized update time comprises transmitting the F1 message by a Central Unit (CU) of the IAB-donor node to a Distributed Unit (DU) of the parent IAB-node.

13. The method of any of the previous embodiments, wherein the synchronized configuration update comprises a configuration update for a Distributed Unit (DU) of each parent IAB-node and/or a Mobile Termination (MT) of the child IAB-node, wherein the configuration update is applied synchronously to the DU of each parent IAB-node and/or the MT of the child IAB-node.

14. The method of any of the previous embodiments, wherein transmitting the synchronized update time to each parent IAB-node to activate the synchronized configuration update comprises one of:
transmitting a specific slot, a specific symbol inside the specific time slot, or a specific frame;
transmitting a specific time, system frame number (SFN), and/or slot number; or
transmitting a delay time or activation delay after reception of a configuration message by the parent IAB-node before activating the configuration update.

15. The method of embodiment 14, wherein the synchronized update time or the activation delay are provided as a new information element in an existing F1 message for a gNB-DU resource configuration or in another F1 message.

16. The method of embodiment 1, wherein transmitting, by the IAB-donor node, the synchronized update time comprises transmitting the synchronized update time or alignment information to the child IAB-node and each of the parent IAB-nodes in separate messages.

17. The method of embodiment 16, wherein the message from the IAB-donor node to the child IAB-node comprises an F1 message or a Radio Resource Control (RRC) message.

18. A method performed by an integrated access and backhaul (IAB) donor node for synchronized activation of a resource configuration, the method comprising:
determining, by the IAB-donor node, a respective transmission time or latency between the IAB-donor node and each parent IAB-node of a plurality of parent IAB-nodes, wherein a child IAB-node is dual-connected to each of the parent IAB-nodes; and
transmitting, by the IAB-donor node, a configuration message to at least each parent IAB-node of the plurality of parent IAB-nodes at a different time based on the respective transmission time or latency between the IAB donor and each parent IAB-node to cause each configuration message to be received by each of the parent IAB-nodes at a same time, wherein the configuration message comprises a configuration update for synchronized activation by each parent IAB-node and/or the child IAB-node.

19. The method of embodiment 18, wherein the configuration message comprises an F1 message.

20. The method of any of the previous embodiments, wherein an inter-donor topology comprises a first IAB-donor node and a second IAB-donor node, and wherein one of the first or second IAB-donor nodes becomes a reference IAB-donor node and determines a synchronized update time to perform the configuration update and the reference IAB-donor node informs another of the first or second IAB-donor nodes of the synchronized update time, and wherein each IAB-donor node determines a time for transmitting the configuration message based on the synchronized update time and the respective transmission time or latency between each IAB-donor node and a respective parent IAB-node.

### Group B Embodiments

21. A method performed by a parent integrated access and backhaul (IAB) node for synchronized activation of a resource configuration, the method comprising:
receiving, by the parent IAB-node, a synchronized update time for performing a synchronized configuration update from an IAB-donor node; and
transmitting, by the parent IAB-node, a trigger to a child IAB-node to perform the synchronized configuration update at the synchronized update time.

22. The method of embodiment 21, wherein transmitting the trigger to the child IAB-node comprises transmitting one of a Medium Access Control-Control Element (MAC-CE) message, a Downlink Control Indicator (DCI) message, or a Backhaul Adaption Protocol (BAP) control Protocol Data Unit (PDU).

23. The method of embodiment 21, further comprising:
receiving, by the parent IAB-node, a UE-associated F1 message comprising an activation timing information for performing the synchronized configuration update from the IAB-donor node; and
transmitting, by the parent IAB-node, the activation timing information to the child IAB-node in a BAP control PDU.

24. The method of any of the previous embodiments, further comprising receiving, by the parent IAB-node, a plurality of configurations before activation of any of the configurations based on the synchronized update time or an activation delay for each configuration, wherein each configuration is received at a different time slot, and wherein the parent IAB-node activates each configuration according to its synchronized update time or activation delay, or the parent IAB-node activates a configuration with an earliest synchronized update time or activation delay and ignores all configurations with a later synchronized update time or activation delay.

### Group C Embodiments

25. A node for synchronized activation of a resource configuration, the node comprising:
processing circuitry configured to perform any of the steps of any of the Group A embodiments; and
power supply circuitry configured to supply power to the processing circuitry.

26. A node for synchronized activation of a resource configuration, the network node comprising:
processing circuitry configured to perform any of the steps of any of the Group B embodiments;
power supply circuitry configured to supply power to the processing circuitry.

References are identified below:
1. 3GPP TR 38.874 NR; Study on integrated access and backhaul V16.0.0, January 2019
2. 3GPP TS 38.473 NG-RAN; F1 application protocol (F1AP), V16.6.0, July 2021
3. 3GPP TS 37.340 NR; Multi-connectivity; Overall description; Stage-2 V16.5.0 March 2021

1-27. (canceled)

28. A method performed by an integrated access and backhaul (IAB) donor node for synchronized activation of a resource configuration, the method comprising:
determining, by the IAB-donor node, a synchronized update time for performing a synchronized configuration update in a plurality of parent IAB-nodes and/or a child IAB-node, wherein the child IAB-node is dual-connected to the plurality of parent IAB-nodes; and
transmitting, by the IAB-donor node, the synchronized update time to at least each parent IAB-node and/or the child IAB-node.

29. The method of claim 28, wherein the synchronized update time is determined by using an estimated packet delay time or transmission time between the IAB-donor node and each parent IAB-node.

30. The method of claim 28, further comprising estimating a packet delay time or transmission time between the IAB-donor node and each parent IAB-node for each IAB-donor node in an inter-donor topology, wherein the inter-donor topology comprises a first IAB-donor node wirelessly linked with a first parent IAB-node and a second IAB-donor node wirelessly linked with a second parent IAB-node.

31. The method of claim 30, wherein the first IAB-donor node and the second IAB-donor node are the same IAB-donor node.

32. The method of claim 30, further comprising exchanging packet delay information between the first IAB-donor node and the second IAB-donor node.

33. The method of claim 32, wherein determining the synchronized update time comprises determining the synchronized update time by each IAB-donor node, and the method further comprises exchanging information between the IAB-donor nodes about the synchronized update time for performing a synchronized update configuration in the parent IAB-nodes and the child IAB-node.

34. The method of claim 30, further comprising coordinating between the first IAB-donor node and the second IAB-donor node for determining the synchronized update time.

35. The method of claim 34, wherein one of the first or second IAB-donor nodes becomes a reference IAB-donor node for determining the synchronized update time, and wherein the reference IAB-donor node transmits the synchronized update time to the other of the first or second IAB-donor nodes.

36. The method of claim 30, wherein transmitting the synchronized update time comprises one of:
transmitting the synchronized update time by each IAB-donor node to its associated parent IAB-node; or
transmitting the synchronized update time by one of the IAB-donor nodes to each parent IAB-node.

37. The method of claim 28, wherein transmitting the synchronized update time to each parent IAB-node comprises transmitting an activation delay to each parent IAB-node before performing the synchronized configuration update.

38. The method of claim 28, wherein the synchronized update time comprises a system frame number and a slot number.

39. The method of claim 28, wherein transmitting the synchronized update time to each parent IAB-node comprises transmitting the synchronized update time in an F1 Application Protocol (F1AP) message.

40. The method of claim 28, wherein transmitting the synchronized update time to each parent IAB-node to activate the synchronized configuration update comprises one of:
transmitting a specific slot, a specific symbol inside the specific time slot, or a specific frame;
transmitting a specific time, system frame number (SFN), and/or slot number; or
transmitting a delay time or activation delay after reception of a configuration message by the parent IAB-node before activating the configuration update.

41. The method of claim 40, wherein the synchronized update time or the activation delay are provided as a new information element in an existing FI message for a gNB-DU resource configuration or in another FI message

42. The method of claim 41, wherein the message from the IAB-donor node to the child IAB-node comprises an F1 message or a Radio Resource Control (RRC) message.

43. A method performed by an integrated access and backhaul (IAB) donor node for synchronized activation of a resource configuration, the method comprising:
determining, by the IAB-donor node, a respective transmission time or latency between the IAB-donor node and each parent IAB-node of a plurality of parent IAB-nodes, wherein a child IAB-node is dual-connected to each of the parent IAB-nodes; and
transmitting, by the IAB-donor node, a configuration message to at least each parent IAB-node of the plurality of parent IAB-nodes at a different time based on the respective transmission time or latency between the IAB donor and each parent IAB-node to cause each configuration message to be received by each of the parent IAB-nodes at a same time, wherein the configuration message comprises a configuration update for synchronized activation by each parent IAB-node and/or the child IAB-node.

44. The method of claim 43, wherein the configuration message comprises an F1 message.

45. The method of claim 43, wherein an inter-donor topology comprises a first IAB-donor node and a second IAB-donor node, and wherein one of the first or second IAB-donor nodes becomes a reference IAB-donor node and determines a synchronized update time to perform the configuration update and the reference IAB-donor node informs another of the first or second IAB-donor nodes of the synchronized update time, and wherein each IAB-donor node determines a time for transmitting the configuration message based on the synchronized update time and the respective transmission time or latency between each IAB-donor node and a respective parent IAB-node.

46. A method performed by a parent integrated access and backhaul (IAB) node for synchronized activation of a resource configuration, the method comprising:
receiving, by the parent IAB-node, a synchronized update time for performing a synchronized configuration update from an IAB-donor node; and
transmitting, by the parent IAB-node, a trigger to a child IAB-node to perform the synchronized configuration update at the synchronized update time.

47. The method of claim 46, wherein transmitting the trigger to the child IAB-node comprises transmitting one of a Medium Access Control-Control Element (MAC-CE) message, a Downlink Control Indicator (DCI) message, or a Backhaul Adaption Protocol (BAP) control Protocol Data Unit (PDU).

48. The method of claim 46, further comprising:
receiving, by the parent IAB-node, a UE-associated F1 message comprising an activation timing information for performing the synchronized configuration update from the IAB-donor node; and
transmitting, by the parent IAB-node, the activation timing information to the child IAB-node in a BAP control PDU.

49. A node for synchronized activation of a resource configuration, the node comprising:
processing circuitry configured to
determine, by the IAB-donor node, a synchronized update time for performing a synchronized configuration update in a plurality of parent IAB-nodes and/or a child IAB-node, wherein the child IAB-node is dual-connected to the plurality of parent IAB-nodes; and
transmit, by the IAB-donor node, the synchronized update time to at least each parent IAB-node and/or the child IAB-node; and
power supply circuitry configured to supply power to the processing circuitry.

50. A node for synchronized activation of a resource configuration, the network node comprising:
processing circuitry configured to
receive, by the parent IAB-node, a synchronized update time for performing a synchronized configuration update from an IAB-donor node; and
transmit, by the parent IAB-node, a trigger to a child IAB-node to perform the synchronized configuration update at the synchronized update time; and
power supply circuitry configured to supply power to the processing circuitry.
